(19) United States
(12) Patent Application Publication
(10) Pub. No.: US 2011/0084650 A1
(43) Pub. Date: Apr. 14, 2011

(54) BATTERY CHARGER

(75) Inventors: Jeffrey KAISER, Roselle, IL (US); Joseph L. St. Romain, Fair Oaks Ranch, TX (US); Joseph T. Charles, Jupiter, FL (US)

(73) Assignee: Charles Industries, Ltd., Rolling Meadows, IL (US)

(21) Appl. No.: 12/901,089

(22) Filed: Oct. 8, 2010

Related U.S. Application Data
(60) Provisional application No. 61/250,365, filed on Oct. 9, 2009.

(51) Int. Cl. H02J 7/00

(52) U.S. Cl. 320/107

(57) ABSTRACT

A battery charger is provided. The charger includes an AC input for connection to a source of AC power and a plurality of DC outputs each being connectable to a battery bank. A user interface is provided for inputting battery information including battery voltage and battery type for each DC output. A main controller is in communication with the user interface and receives the battery information from the user interface. The main controller uses the battery information to provide independent charging instructions for each DC output. At least one power module is in communication with the main controller and receives the charging instructions from the main controller. The power module is configured to convert the AC power from the AC input to DC power and is selectively connectable with each of the plurality DC outputs. The power module is configured such that the charging instructions from the main controller direct the power module as to which DC output to connect and a charge voltage and a charge amps to be provided by the power module to that DC output.

### BACKGROUND OF THE INVENTION

Battery chargers can be used in a variety of applications. For example, battery chargers are used in marine applications to provide the power that is needed to maintain the batteries on a boat in a fully charged condition, or in the case of a discharged battery, to restore the battery to a fully charged condition. In addition, the battery charger is often used in conjunction with one or more of the batteries on the boat as a power source to supply DC systems (such as lighting and controls) with power.

The battery charger is primarily used when a boat is at dock and the engines are off. In such instances, the battery charger is plugged into an AC power source provided on shore and the battery charger then converts the AC power to DC power to supply the batteries. Occasionally, an onboard generator is used as the AC power source, instead of power from shore. However, the battery charger operates the same regardless of the source of the AC power.

Boats often have several sets of multiple batteries (known as “banks”) A smaller boat may have only a single bank of batteries, while a larger boat may have up to 4 banks of batteries. The banks may be grouped and configured to supply power to a specific section of a boat. For instance, a typical 3 bank boat setup might include an engine start battery bank, a house battery bank for running, for example, lighting on the boat and a bow thruster battery bank for driving the electric motor associated with a bow thruster which used for tight maneuvering of the boat. Each of the bank is electrically separated from the others during discharge mode. For example, the house battery bank can be discharged by use, while the engine start bank maintains full charge to start the boat.

Boats, particularly more modern and sophisticated ones, often utilize different battery technologies for different battery banks For example, the battery bank associated with the bow thruster may include one or more relatively smaller absorbed glass mat (AGM) batteries, while the house battery bank, which may be mounted further aft in the boat, can include one or more relatively larger capacity flooded cell batteries. Each of these battery banks has different charging needs because of the different battery technologies employed. In particular, different battery types can have different charging algorithms to ensure proper charging of the battery. Moreover, the nominal voltage of the batteries used for the battery banks can also vary depending on the application. Typically, the nominal voltage on the battery banks is 12 VDC or 24 VDC. On any particular boat, the battery banks may all have the same voltage or they may have a combination of different voltages, with each bank having a different voltage. The different battery technologies and nominal voltages that can be used in boats, and in even in the different battery banks of a single boat, can make it difficult to provide a suitable battery charger for marine applications. Unfortunately, commercially available battery chargers do not possess the flexibility necessary to readily adapt to these types of situations.

### BRIEF DESCRIPTION OF THE SEVERAL VIEWS OF THE DRAWING(S)

FIG. 1 is a front view of an exemplary battery charger according to the invention.

FIG. 2 is a block diagram of the master controller of the battery charger of FIG. 1.

FIG. 3 is a block diagram of a power module of the battery charger of FIG. 1.

FIG. 4 is a block diagram of a digital feedback circuit for controlling the output conversion of the power module of FIG. 3.

### DETAILED DESCRIPTION OF THE INVENTION

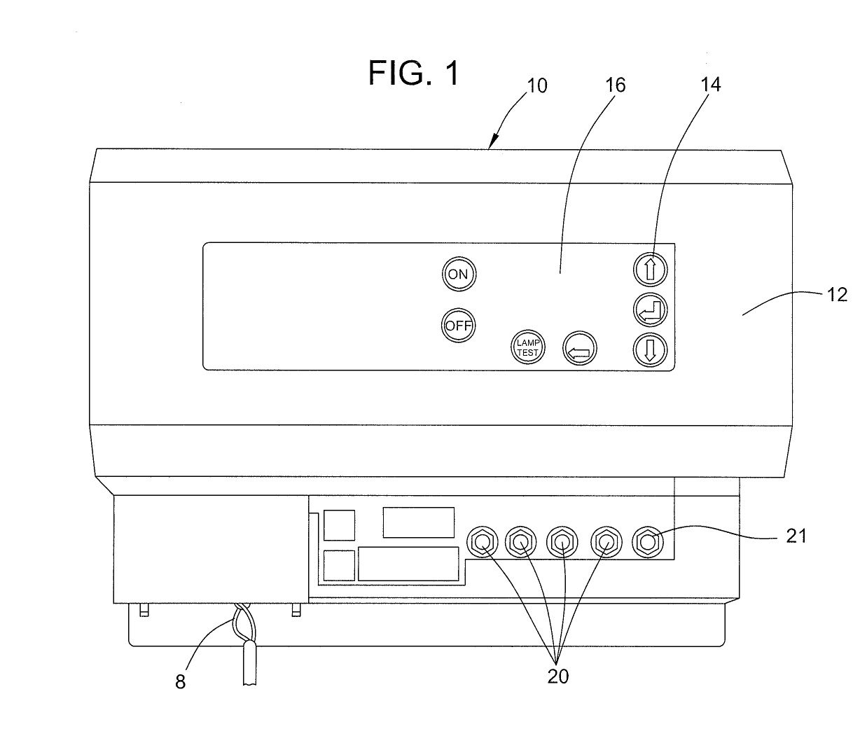

Referring to FIG. 1 of the drawings there is shown an illustrative embodiment of a battery charger 10 according to the present invention. The battery charger 10 can be used to maintain batteries in a fully charged condition and to restore a discharged battery to a fully charged condition. The illustrated battery charger is configured for use in marine applications and, in particular, to charge one or more batteries or battery banks (i.e., a set of one or more batteries) on a boat. Hereinafter, the battery charger 10 will be described as be connectable to battery banks, however, those skilled in the art will appreciate that a bank could include just a single battery. Moreover, while the invention will be described in some aspects in connection with use on a boat, those skilled in the art will understand that the teachings of the present invention are equally applicable to other applications including any application involving the charging of multiple batteries.

In the illustrated embodiment, the battery charger 10 includes a housing 12 within which the electronic components associated with the charger are contained. As the illustrated embodiment is particularly intended for marine applications, the housing 12 can be designed to protect the electronic components therein from exposure to the elements particularly water. In this case, the lower section of the front face of the housing 12 includes various input and output connections as discussed in greater detail below.

In order to allow a user to input information into the battery charger 10, including set-up information, the front face of the battery charger housing further includes a user interface 14. In this case, the user input keyboard is a capacitive touch screen 14 that advantageously has no moving switches. With this type of touch screen 14, the placement of a finger changes the capacitance measured on a sensing plate, indicating a virtual switch closure. Dirt and other contaminants getting on the switch contacts is not an issue because there are no switch contacts. This arrangement allows a user to input information into the system with a high degree of reliability. The front face of the battery charger housing 12 can further include a display 16 on which various operating parameters and/or input settings may be displayed for the user. The user may be the boat owner or in many cases is the manufacturer of the boat or other equipment on which the charger is installed.

For connecting to an AC power source that supplies the power for charging the batteries, the battery charge includes a AC power input 18. In this instance, the AC power input 18 is located behind a panel on the front face of the battery charger 10. The AC input 18 of the battery charger is configured to receive AC power from any suitable source including, for marine applications, an on-shore power source provided at a dock or an AC generator on-board the boat. Advantageously, the battery charger 10 can be configured with a universal AC voltage input 18 that allows a user to connect to any AC power source from 95 VAC to 265 VAC, 50 or 60 Hz without switching or reconfiguring the charger. According to one preferred embodiment of the invention, this is accomplished using a power factor correction (PFC) circuit. A PFC circuit operates as a power supply boost converter. The input power is chopped into small slices and boosted to an intermediate voltage, which in this case is 390 VDC. As long as the input voltage is in a specified range, it is boosted to the intermediate voltage, which becomes a known reference voltage in the system. One advantage of this is that the reference voltage can be filtered with storage capacitors which allows the system to ride out the times when the AC input sine-wave crosses zero and there is no power available. In a preferred embodiment, PFC chips available from STMicroelectronics of Geneva, Switzerland are used to implement the universal AC voltage input 18.

In order to allow the battery charger 10 to provide charging for multiple battery banks, the battery charger 10 of the invention is provided with multiple DC power bank outputs 20 each of which is connectable to a different battery bank. In the illustrated embodiment, the battery charger includes four DC power bank outputs 20, making the battery charger 10 connectable to up to four different battery banks These bank outputs 20 are provided on a lower portion of the front face of the housing 12 as shown in FIG. 1. Those skilled in the art will appreciate that the battery charger 10 could include more or less bank outputs 20. In this case, a ground connection 21 is provided on the battery charger housing 12 adjacent the bank outputs 20.

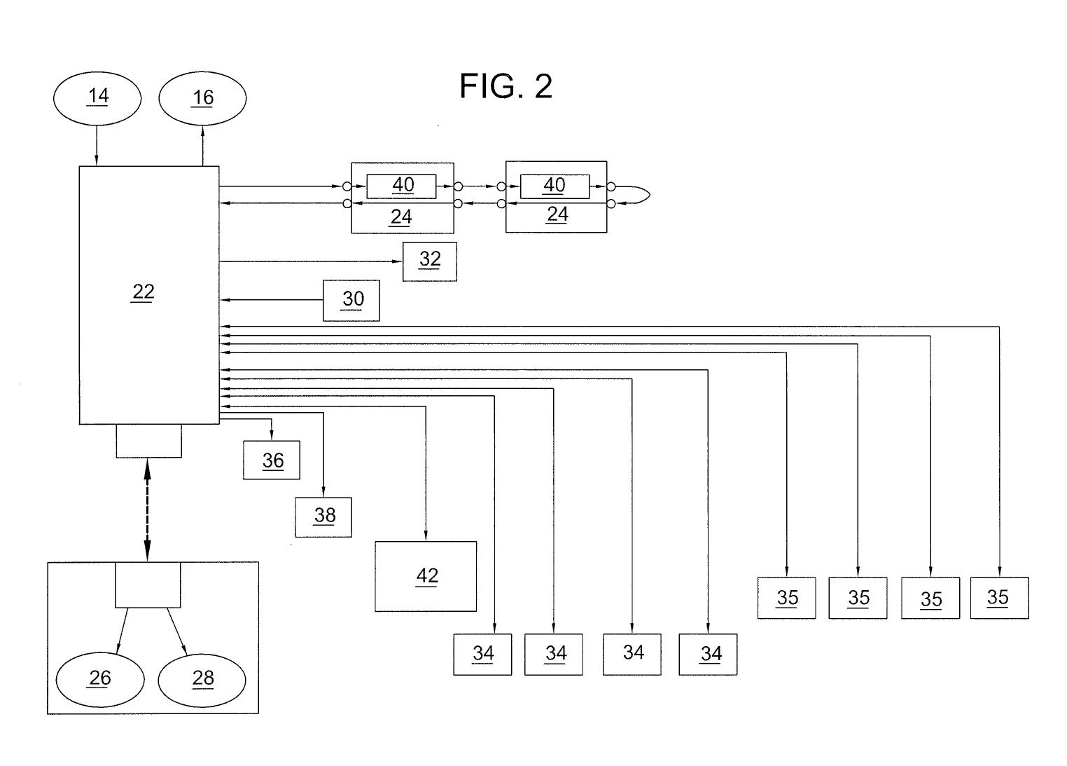

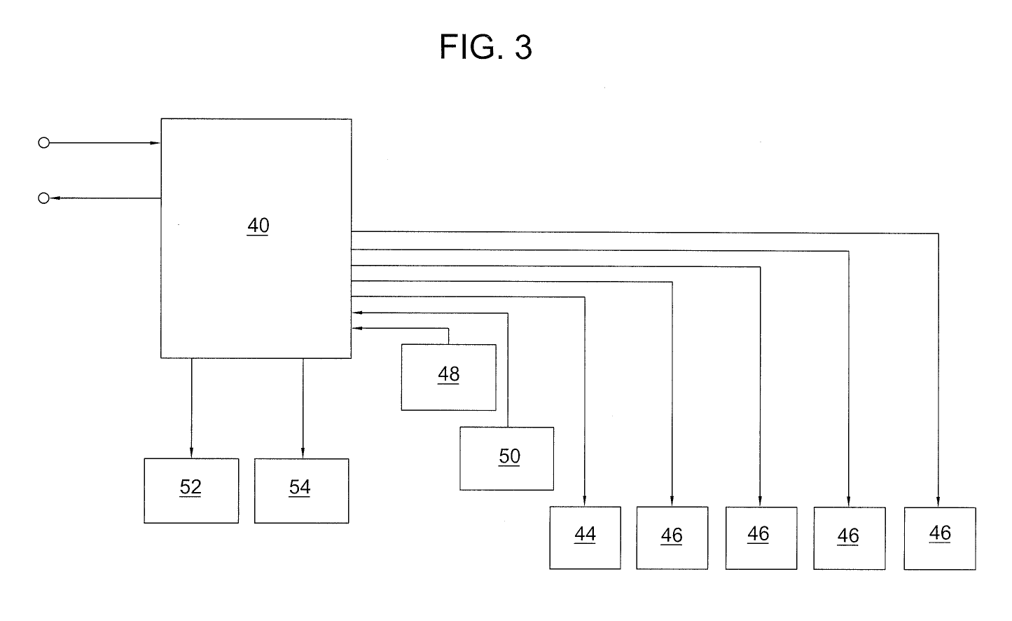

For directing and controlling the charging operations of the multiple battery banks through the bank outputs 20, the battery charger 10 can include a master controller 22 (shown schematically in FIG. 2) and one or more power modules 24 (one of which is shown schematically in FIG. 3). The illustrated master controller 22, as shown in FIG. 2, is in communication with and receives inputs from the touch screen 14 and provides outputs to the display 16 on the face of the battery charger 10. Optionally, the master controller 22 can also be connected to a remote keyboard 26 and display 28 via a cable or the like in order to facilitate, for example, the set-up programming of the battery charger. The illustrated master controller 22 further includes a first temperature sensor 30 for sensing the internal temperature of the battery charger 10 and is in communication with and controls the operation of a fan 32 that can be used as needed to cool the interior of the battery charger. The battery charger 10 can also include remote temperature sensors 34 that can be arranged at each battery bank connected to the battery charger 10. The, in the illustrated embodiment, four remote temperature sensors 34 are in communication with the master controller 22 as shown in FIG. 2. The illustrated master controller 22 also includes connections to reverse voltage sensors 35 associated with each of the bank outputs 20 that provide a signal when the associated battery bank is connected up backwards. The illustrated master controller 22 can further provide outputs to various alarm relays 36 as well as an audible buzzer 38 to provide signals for any potential problems. Connections for the remote temperature sensors 34, the optional remote keyboard 26 and display 28 and the alarm relays 36 can be provided on the housing of the battery charger.

The main controller 22 is also in communication with one or more power modules 24 that, in this case, are directly responsible for providing power to the bank outputs 20 of the battery charger 10 and thereby to the connected battery banks In the embodiment illustrated in FIG. 2, the main controller 22 is in communication with two power modules 24. The number of power modules 24 present depends on the desired output power of the battery charger 10. According to one preferred embodiment, the battery charger 10 is configured with multiple 20 amp power modules 24 operating together to produce larger output power. These modules 24 may be combined to produce a single higher output for a single battery bank or each module may route power to an individual battery bank. For example, a 80 amp charger 10 consisting of four power modules 24 could supply 80 amps to a single bank or 20 amps to each of the four battery banks or some other combination. A schematic block diagram of a single power module 24 is shown in FIG. 3. As shown in FIG. 3, each power module 24 has an associated microprocessor 40 that is in communication with the master controller 22 and that directs operation of that particular power module 24 in response to instructions received from the master controller 22.

As will be appreciated from the discussion below concerning the operation of the battery charger 10, the main controller 22 and the individual power modules 24 can be provided with suitable software such that charger 10 can provide isolated power to each individual bank output 20 to recharge and maintain power on the battery bank connected thereto. In this case, the battery charger 10 is configured such that no two battery banks are charged at exactly the same time. In particular, the software associated with the main controller 22 employs a bank selection system that includes a round robin charging algorithm. The algorithm chooses the bank to charge and commits some or all of the battery charger's output to the associated bank output 20. The bank to charge changes based on the power needs of the individual banks as determined by the algorithm.

To allow each bank output 20 of the battery charger 10 to be connected to a different type of battery bank, the master controller 22 and power modules 24 are configured such that the charging parameters for each output to a bank can be customized. In particular, each bank output 20 on the battery charger is user selectable between 12 VDC and 24 VDC. Users select the output voltage of the charger to correspond with the batteries in each bank using the user interface, for example, the touch screen 14. Each individual bank output is independent of the other. Unlike previous chargers, this allows the charger 10 to be used in applications that have mixed 12 VDC and 24 VDC battery banks Moreover, each bank output 20 on the battery charger 10 of the invention is user selectable between several different standard battery types. For example, in one preferred embodiment, each bank output 20 is selectable between the following battery types: flooded lead acid; gel; absorbed glass mat; or nickel cadmium. Using the input touch screen 14, a user selects the bank type to correspond with the batteries connected to each bank. As with the voltage, each individual bank output 20 is independent of the other. Thus, unlike previous chargers, the battery charger 10 of the present invention can be used in applications having mixed battery types.

According to one preferred embodiment, selecting the output voltage (12/24 VDC) and type of battery is done with a menu system that is implemented via the touch screen 14. The master controller 22 software then looks up the ideal charge programming algorithm for that battery type and voltage which is used to provide the charging instructions to the power modules 24. The charger 10 is further configured such that the user can change the boost and float voltages as they see fit if they don't like the recommended settings provided by the selected charge programming algorithm. These changes can be made again via the touch screen 14 and then the software on the master controller 22 adjusts the charging algorithm in accordance with the changes entered by the user. For example, this can allow the charger to be programmed to compensate for a longer wire to a battery bank that may produce a slightly higher voltage drop.

The charger 10 can also be configured so as to allow a user to set the maximum output amps produced by charger 10 in order to accommodate different capacity battery banks. Again, this information can be entered via the touch screen 14 and implemented into the charging instructions by the master controller 22. According to one preferred embodiment, the user can set the maximum output amps to anything between 5 amps and the maximum output of the charger 10. For example, with a 60 amp charger 10, the maximum 60 amp output may be too large for a small capacity battery bank. In such a case, the user could turn down the output amperage on that battery bank. All of the selections made through the touch screen 14 can be stored in a non-volatile memory button 42 (shown in FIG. 2) in communication with the master controller 22 so if the charger 10 should fail, the settings can be transferred to a replacement charger.

The illustrated battery charger 10 operates as follows. First, no matter what output voltage or battery type is selected, the PFC (power factor correction) circuit takes the input AC voltage from the input 18 and converts it to an intermediate voltage, in this case 390 VDC. Each power module 24 includes its own PFC circuit. Then, depending upon the selection made by the user, the master controller 22 sends a message to the microprocessor 40 associated with each of the power modules 24 that will be involved in the charging to, in this case, energize (24 volt mode) or de-energize (12 volt mode) a voltage selection relay 44 (see FIG. 3). In the same message, the master controller 22 also tells the power module microprocessor 40 which bank output 20 to select. To this end, each power module 24 includes, in the illustrated embodiment, four output bank relays 46 with each relay corresponding to one of the bank outputs of the charger. Generally, all of the power modules 24 are set to the same relay configuration, but the master controller 22 software could make different relay configurations if needed. When the output bank 20 to charge is active, the bank relay 46 either accepts the 12 VDC taps or the 24 VDC taps of a down converter transformer of the respective power module 24. This transformer takes the intermediate voltage of 390 VDC and converts it to the proper voltage for charging. Since the intermediate voltage is known, it makes down converting the voltage easier. According to one preferred embodiment, the down converter transformer obtains power conversion from a STMicroelectronics resonant converter chip.

After the relays 44, 46 are set and a small amount of time has passed to allow the relays to settle, the master controller 22 sends a message to set the desired output voltage and maximum amps to the microprocessor 40 of a “first” power module 24. Note that in this example all of the bank relays 46 on all of the power modules 24 are set to the same configuration. With a single power module 24 (e.g., 20 amp) system, this is the only message that is sent. However, in systems with two or more power modules 24, the other power modules 24 get a slightly different message from the main controller 22 that instructs the microprocessor 40 of the respective power module 24 to only regulate the output amps and not be concerned with the output voltage. This is because the outputs of the power modules 24 are tied together in parallel. If all of the power modules 24 tried to regulate voltage, they would fight. Accordingly, the master controller 22 software is set-up to only instruct the first power module 24 to regulate output voltage and all modules 24 regulate their output amps. For example, with a three power module 60 amp system, the first power module 24 regulates both voltage and amps, while the other two power modules 24 only regulate amps. To allow the microprocessor 40 to control, as needed, the output voltage and/or amps, each power module 24 includes an output voltage sensor 48 and an output current sensor 50 that are in communication with the microprocessor 40 of the power module 24 as shown in FIG. 3.

The power modules 24 are not informed about the battery type or whether the charging is boost/float mode. This is only known by the master controller 22. The power modules 24 don't need to know as they are configured to output the voltage & current as prescribed by the charging instructions provided by the master controller 22. Initially, the master controller 22 tells the power modules 24 to output at a set voltage and current based on the user input voltage and battery type and the cataloged charging algorithms. Then every few seconds, the master controller 22 updates the power modules 24 with new information. During the time between updates, the power modules 24 run autonomously and try to achieve the previous setting received from the master controller 22 using feedback based on the output voltage and output current sensors 48, 50. As time passes, the master controller 22, which knows the charging algorithm, continuously changes the output of the power modules 24 to match the desired output.

In the illustrated embodiment, all communication from the master controller 22 to the power modules 24 is serial communication. The protocol is the master controller 22 speaks and then the power modules 24 send a reply. The power modules 24 can not send a reply autonomously. In particular, the master controller 22 sends messages to the microprocessors 40 of the relevant power modules 24 with the desired settings. The power modules 24 return the sensed voltage and output current data from the corresponding sensors 48, 50 to the master controller 22. To prevent run-away, if the power modules 24 don't hear a message from the master controller 22 within a set period of time, the power modules 24 assume the master controller 22 or a communication link has failed and proceed to shut down the output to the battery banks via a fail-safe mode. As soon as the communication is restored, the system resumes charging. Similarly, the master controller 22 needs to hear a reply from the power modules 24 or the master controller 22 thinks a power module has failed.

To control the output voltage, the output voltage on the first power module 24 is sensed and compared to the desired voltage. If the sensed output voltage is different than that desired voltage, the power module 24 raises or lowers the output voltage to compensate. How this is accomplished is described in greater detail below. The sensed output amps are also compared to the desired range. In the illustrated embodiment, the amp output cannot be controlled directly on the power module 24. Instead, the power module microprocessor 40 controls the output voltage up and down slightly to regulate the output amps. A higher output voltage produces higher amps and a lower output voltage lowers the amps. However, this is not a proportional scale, instead it changes continuously based on the battery banks connected and the load. Therefore, feedback from the output current sensor 50 can be important.

If the battery charger 10 includes multiple power modules 24, the amp output may be shared between modules. For example, with a 60 amp charger with three power modules 24, all three power modules 24 can output 20 amps for a total of 60 amps. If the output demand is only 45 amps, then each module 24 can output approximately 15 amps (although some may be slightly more or less than 15 amps). In some operating conditions, one or more of the modules 24 can shutdown. For example to produce an total output of 36 amps, instead of each of the three modules 24 outputting 12 amps, one module could be turned off and the other two modules can output 18 amps each. This allows the power modules 24 to run as close to full output as possible, which is more efficient and allows for better output regulation.

The master controller 22 determines when to turn on/off a power module 24. When turning off a power module 24, the master controller 22 slowly turns up the desired amperage output on the remaining active power modules 24 and slowly turns down the output amperage of the power module 24 that is being turned off. This is provides a seamless transfer that is unnoticeable to the user. The opposite happens when the output demand increases. The master controller 22 turns on the new power module 24 and slowly brings its amp output up to balance the amp load between all the active power modules 24. In doing so, the master controller 22 may decrease the amp output of some power modules while increasing the amp output of others.

If the battery charger 10 includes two or more power modules 24, the master controller 22 can be configured to disable a power module 24 if the master controller 22 determines the power module is not operating properly while still operating the system with the remaining power modules. This is unique as most battery chargers that have a failure turn off the output completely, leaving the user without any battery charging capability. This is accomplished by using the master controller 22 to compare the sensed output current of each power module 24 (from current sensors 50 and feedback from the power module microprocessor 40) to an expected output amp tolerance (e.g., +/−5 amps). If the output current is not within the expected tolerance, it is probably malfunctioning and it shut down by stopping the resonant down converter. The charger 10 then only functions on the remaining power modules 24. Additionally, the system can be configured to inform the user that a module 24 has problems via the screen and/or other suitable alarms. For shutting down a power module 24, the microprocessor 40 of each power module can signal a halt function 52 (see FIG. 3), (as will be appreciated the signal for the halt function may initially come from the master controller 22) which shuts down the module by turning off the PFC circuit associated with the module.

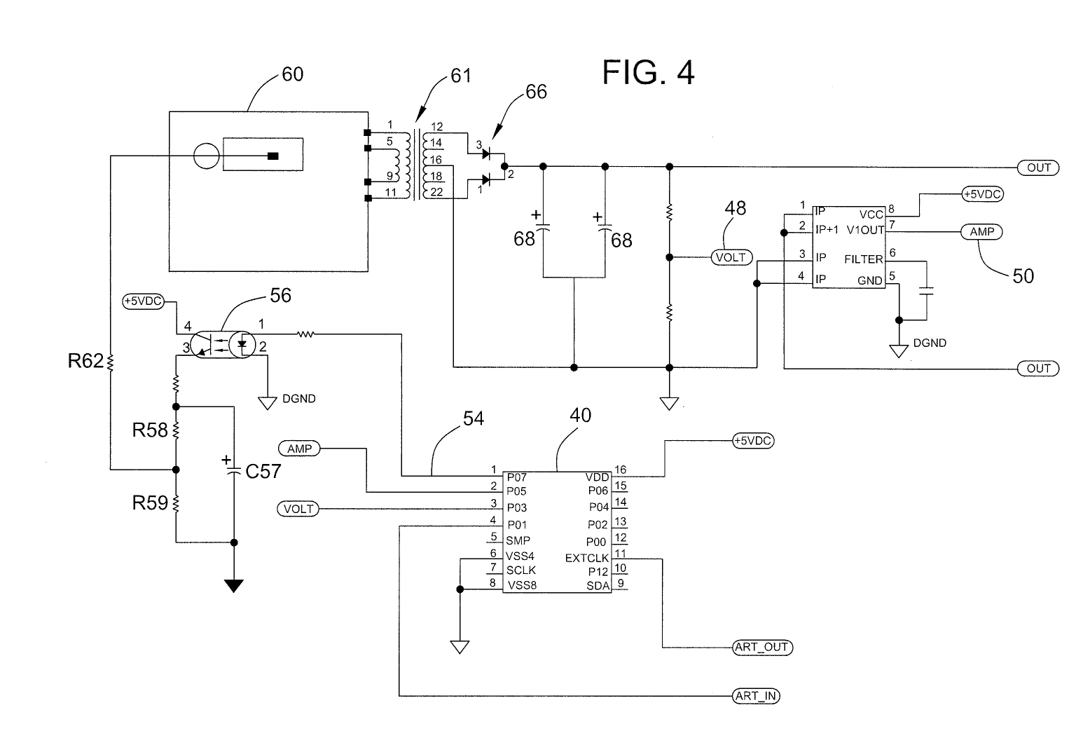

For controlling the output conversion of the intermediate voltage to the desired battery voltage and amps, a digital feedback circuit is used in each power module 24. The digital feedback operates as follows with specific reference to FIG. 4 of the drawings. As discussed above, the voltage and amp output of the power module 24 are read by the microprocessor 40 of the power module. After filtering via software, they are compared to the ideal values received from the master controller 22. A pulse width modulator (PWM) in the power module 24 is adjusted according to the result of the comparison with the length of pulses being made longer if the voltage and/or amps need to be increased and being made shorter if the voltage and/or amps need to be decreased. The PWM signal 54 that is output from the power module microprocessor is also shown in FIG. 3.

The PWM digital pulse 54 is fed through an opto isolator 56 to maintain AC input to DC output isolation. Advantageously, the opto isolator 56 can be run to saturation and therefore, temperature has a very minimal affect on the output of the opto isolator. On the output side of the opto isolator 56, capacitor C57 filters the PWM pulse. The voltage on C57 is directly proportional to the length of the PWM pulse 54, with a larger PWM pulse raising the voltage on C57. Resistors R58 & R59 in the circuit have dual purposes. The resistors R58/R59 first act as a constant drain to prevent capacitor C57 from overfilling and draining C57 down when the PWM pulse 54 is shortened. The second purpose is to act as a voltage divider and current sink. In this case, the resonant converter 60 control chip's output is controlled by current draw on one of the pins. By increasing the current draw on this pin, the resonant converter's 60 frequency is increased and the output power goes down (and hence the output to the battery is reduced). By reducing the current draw on this pin, the resonant converter's 60 frequency is decreased and the output power goes up (and the output to the battery is increased). The current draw in this pin of the resonant converter 60 is directly proportional to the voltage drop across R62. The voltage drop across R62 is directly proportional to the voltage across C57 as seen thru the voltage divider R58/R59.

The reference voltage input from the PFC is changed by the resonant converter 60 into a high frequency sine-wave that passes through transformer 64. Transformer 64 converts the reference voltage into a lower voltage. A rectifier 66 rectifies the sine-wave back into DC (in this case 12 V or 24 V depending on the taps of the transformer, only 24 VDC taps are shown in FIG. 4 for simplicity). Filter capacitors 68 smooth the rectified DC and the power is ready to be sent to the batteries. The voltage and current output sensors 58, 60 that provide feedback to the power module microprocessor are also shown in FIG. 4. The illustrated voltage sensor 58 is a simple voltage divider that provides a signal to the microprocessor 40 that is proportional to the sensed voltage. The illustrated current sensor 60 is a hall effect current sensor.

In the illustrated embodiment, only digital feedback is used for control in the power modules 24. Moreover, the resonant converter chip is current regulated, not voltage. Such an arrangement offers several advantages over analog feedback circuits. For example, it is much more reliable and not effected by temperature. With an analog feedback circuit, temperature variations cause the opto isolator to radically change parameters. This requires even more circuitry to compensate for the temperature change. With the digital circuitry, significantly fewer components, which have a very high reliability rate and are not affected by temperature, can be used.

To obtain better resolution, the digital feedback circuit can be configured with dithering via the software associated with the microprocessor 40 of the respective power module 24. For example, the PWM is limited to 256 bit resolution meaning, without dithering, there only can be 256 voltage steps. Adding a larger PWM for more resolution adds cost. Instead, the PMW output can be dithered. By using a 10 step dither, the resolution can be effectively increased by a factor to 10, so to provide 2560 voltage steps. Dithering works by diving 2560 steps by 256. This obtains a constant “X” which is the result of the division: X=PWM setting/256. Any fractions are dropped to produce only whole numbers. As a result, a remainder (R) from 0 to 9 is left. To get the dithering, the PWM pulses are grouped into sets of 10. For first part of the pulse, the pulse width plus 1 (X+1) is transmitted. This is a slightly wider pulse. For the second part of the pulse, the pulse width is set for (X), or slightly narrower. The remainder R controls how many wider pulses vs. narrower pulses are present. For example: If R is 6, then six of the pulses in a row are (X+1) pulse width and three of the pulses are (X). If R is 3, then three of the pulses in a row are (X+1) pulse width and 6 are (X) pulse width. As the remainder grows, the voltage increases in 0.1 PWM pulse increments. As the remainder is reduced, the voltage decreases in 0.1 PWM pulse decrements.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A battery charger comprising:
an AC input for connection to a source of AC power;
a plurality of DC outputs each being connectable to a battery bank;
a user interface for inputting battery information including battery voltage and battery type for each DC output;
a main controller in communication with the user interface and that receives the battery information from the user interface; the main controller being configured to use the battery information to provide independent charging instructions for each DC output; and
at least one power module in communication the main controller and that receives the charging instructions from the main controller, the power module being configured to convert the AC power from the AC input to DC power and being selectively connectable with each of the plurality DC outputs, wherein the power module is configured such that the charging instructions from the main controller direct the power module as to which DC output to connect and direct a charge voltage and a charge amps to be provided by the power module to that DC output.

2. The battery charger of claim 1 wherein the power module is one of a plurality of power modules.

3. The battery charger of claim 2 wherein each of the plurality of power modules is configured to produce a maximum of approximately 20 amps.

4. The battery charger of claim 2 wherein each of the power modules includes an output voltage sensor and an output current sensor.

5. The battery charger of claim 2 wherein a first of the plurality of power modules is configured to regulate the output voltage and output current supplied to a respective DC output using feedback from the voltage and current sensors and based on the charge voltage and the charge current from the charging instructions provided by the master controller.

6. The battery charger of claim 5 wherein the power modules other than the first power module are configured to regulate the output current, but not the output voltage, supplied to the respective DC output using feedback from the current sensor and based on the charge current from the charging instructions provided by the master controller.

7. The battery charger of claim 6 wherein the power modules are configured to regulate output current by adjusting output voltage.

8. The battery charger of claim 4 wherein the power modules communicate information from their respective current and voltage sensors back to the master controller.

9. The battery charger of claim 8 wherein the master controller is configured to disable a power module that is not operating properly based on information from at least the current sensor communicated from that power module while still providing charging instructions to the other power modules.

10. The battery charger of claim 1 wherein the power module includes a voltage sensor and a current sensor and the power module is configured to regulate the output voltage supplied to a respective DC output using a digital feedback circuit based on information from the voltage and current sensors and based on the charge voltage and the charge current from the charging instructions provided by the master controller.

11. The battery charger of claim 10 wherein the digital feedback circuit includes a pulse width modulator in the power module.

12. The battery charger of claim 11 wherein an output of the pulse width modulator is dithered.

13. The battery charger of claim 1 wherein communication between the master controller and the power module is serial communication.

14. The battery charger of claim 1 wherein the battery charger includes a housing and the user interface is a touch screen provided on the housing.

15. The battery charger of claim 1 wherein the power module is configured such that the AC input can be connected to AC power sources of different voltages.

16. The battery charger of claim 1 wherein the battery charger includes at least four DC outputs.

17. The battery charger of claim 1 wherein the battery information on battery type input via the user interface includes an indication of a flooded lead acid, gel, absorbed glass mat or nickel cadmium battery type.

18. The battery charger of claim 1 wherein the battery voltage battery information input via the user interface includes an indication of 12 V or 24V.

19. The battery charger of claim 1 wherein the battery information input via the user interface can further include a boost and/or a float voltage and the main controller uses the boost and/or float voltage battery information to provide the independent charging instructions for each DC output.

20. The battery charger of claim 1 wherein the power module includes a resonant converter chip.
